(19) United States
(12) Patent Application Publication
(10) Pub. No.: US 2011/0119952 A1
(43) Pub. Date: May 26, 2011

(54) DRYING METHOD AND CONDENSATION DRYER COMPRISING A HEAT PUMP AND SYSTEM FOR RECOGNIZING AN UNALLOWABLE OPERATING STATE

(75) Inventors: Thomas Nawrot, Berlin (DE); Ulrich Nehring, Berlin (DE)

(73) Assignee: BSH BOSCH UND SIEMENS HAUSGERÄTE GMBH, Munich (DE)

(21) Appl. No.: 13/054,964

(22) PCT Filed: Jul. 28, 2009
(86) PCT No.: PCT/EP09/59706

§ 371 Date: Jan. 20, 2011

(30) Foreign Application Priority Data
Jul. 30, 2008 (DE) 10 2008 040 853.0

(51) Int. Cl. F26B 5/00

(52) U.S. Cl. 34/427; 34/524

(57) ABSTRACT

A condensation dryer is provided that includes a drying chamber for items to be dried; a process-air circuit having a first fan; a heat pump in which a coolant circulates; an evaporator; a compressor; a condenser; a throttle; a temperature sensor to measure a temperature of the coolant; a cooler for the heat pump; and a controller. The condensation dryer further includes a comparator to compare the measured temperature of the coolant to a limit temperature that is stored in the controller and to switch on and operate the cooler during a period of time if the measured temperature of the coolant is equal to or greater than the limit temperature. The condensation dryer also includes an evaluator to evaluate a change in the measured temperature of the coolant during the period of time with regard to a non-permitted operating state of the condensation dryer.

The invention relates to a condensation dryer comprising a heat pump and recognition of an unallowable operating state, and to a preferred method for the operation thereof.

In a condensation dryer, a fan carries air (so-called process air) via a heater into a drum which holds moist laundry items and acts as a drying chamber. The hot air absorbs moisture from the laundry items to be dried. After passing through the drum, the then moist process air is carried into a heat exchanger, which is usually preceded by a fluff filter.

In a heat exchanger (e.g. air-air heat exchanger or heat sink of a heat pump), the moist process air is cooled, such that the water contained in the moist process air condenses. The condensed water is then generally collected in a suitable container, and the cooled and dried air is carried back to the heater (which can optionally be the heat source of a heat pump) and then to the drum.

This drying activity can be very energy-intensive, since the cool air stream that is warmed as a result of cooling the process air in the heat exchanger can be lost to the process in terms of energy. The energy loss can be markedly reduced by using a heat pump. In a condensation dryer that is equipped with a heat pump, the cooling of the warm moisture-laden process air essentially takes place in a heat sink of the heat pump, where the heat that is taken from the process air is used e.g. for evaporating a coolant that circulates in the heat pump. The heat that is absorbed in the heat sink is transported within the heat pump to the heat source, where it is released again, possibly as a result of an increased temperature relative to that at the heat sink. In a heat pump which works using a coolant as a heat transport means, wherein the coolant evaporates in the heat sink and condenses in the heat source, the evaporated gaseous coolant arrives via a compressor at the heat source, which can be referred to as a condenser here, where heat is released due to the condensation of the gaseous coolant, said heat being used to heat the process air before it enters the drum. The condensed coolant finally flows back to the evaporator through a throttle; the throttle is used to reduce the internal pressure in the coolant, such that this can evaporate in the evaporator by absorbing heat again. The heat pump, which is operated thus with the aid of a circulating coolant, is also known as a “compressor heat pump”. Other constructions of the heat pump are also known.

DE 40 23 000 C2 describes a tumble dryer comprising a heat pump, wherein an incoming-air opening is arranged between the condenser and the evaporator in the process-air channel, and can be sealed by means of a controllable sealing entity.

DE 44 09 607 A1 describes a condensation dryer comprising a closed process-air circuit and a heat-pump entity comprising a coolant circuit in which coolant circulates in a line system comprising an evaporator, a compressor, a condenser and a throttle, wherein a device for cooling the coolant is arranged in at least one entity of the coolant circuit. In one embodiment, a measuring device for capturing the coolant temperature or the coolant pressure is arranged in the coolant circuit and, depending on the values that are captured by the measuring device, an evaluation circuit controls the pump device, the cool-air fan, the regulating device for the incoming-air valve or outgoing-air valve, or the rotational speed of the compressor motor.

WO 2008/086933 A1 discloses a condensation dryer comprising a drying chamber, a process-air circuit, in which a heater is provided for warming the process air and in which the warmed process air can be carried by means of a fan over the items to be dried, an air-air heat exchanger, and a heat-pump circuit comprising an evaporator, a compressor and a condenser. An additional heat exchanger is located between condenser and evaporator in the heat-pump circuit, and is functionally coupled to the air-air heat exchanger. The temperature of the coolant in the heat pump, in particular in the condenser, is maintained in the allowable range by the controller that is provided for heat pump and additional heat exchanger. Temperature sensors are also installed in the heat-pump circuit and/or in the process-air circuit for the purpose of regulating the coolant temperature or heat pump temperature and the process-air temperature.

EP 1 884 586 A1 discloses a tumble dryer comprising a heat-pump circuit for carrying a medium through a condenser, a throttle organ, an evaporator and a compressor, back to the condenser, wherein the process air can be warmed by the condenser and cooled by the evaporator, wherein an additional heat exchanger is arranged in the heat-pump circuit for the purpose of extracting heat from the heat-pump circuit. The additional heat exchanger is arranged between the condenser and the throttle organ. In certain embodiments, the tumble dryer features a fan for cooling the additional heat exchanger with the aid of ambient air, said fan being controlled as a function of a temperature in the process circuit and/or in the heat-pump circuit. The fan is preferably controlled as a function of a temperature T1 of the medium between the additional heat exchanger and the throttle organ, for example, wherein a power of the fan is increased in particular as a function of the extent to which the temperature T1 is greater than a reference temperature T0.

DE 197 28 197 A1 discloses a method for recognizing unallowable operating states in a tumble dryer, and a corresponding tumble dryer. The method is intended to allow the individual or combined detection of different operating states having excessive temperature, wherein said states come from different regions. The temperature is periodically captured in the incoming air stream above an incoming-air heater and before the laundry drum, a difference value or gradient is formed from two consecutively captured values, this difference value (gradient) is compared with a predefined difference value (gradient), wherein, if the newly formed difference value is actually greater than the predefined difference value, a count value is incremented by one step, this count value is compared with a predefined count value and, if the current count value is greater than the predefined count value, the heater of the tumble dryer is switched off and/or an operating state indicator is activated.

The conventionally used air-air heat exchanger (intersection or counterflow operation) and the electric heater are generally replaced completely by a heat pump. In comparison with a dryer featuring an air-air heat exchanger and resistance heating, a reduction of 20% to 50% in the energy requirement for a drying process can be achieved thereby.

A compressor heat pump usually works at its best in specific temperature ranges in the evaporator and in the condenser. When using a compressor heat pump in the condensation dryer, a problem arises in the form of the generally high temperature in the condenser, a possible consequence of this being that, depending on the process involved, the coolant can no longer be condensed or can no longer be condensed completely; the compressor must then be switched off and/or a significantly reduced efficiency of the heat pump must be accepted. This problem becomes even greater if the compressor is assisted by an additional heater in the process-air circuit, in order to achieve faster heating of the process air and therefore shorter drying times. Moreover, soiling of the airways can cause an obstruction of the circulating process air. This can also result in an increase in the temperature of the coolant. Such operating states can adversely affect the heat pump or other parts of the dryer and are therefore unallowable.

In a conventional dryer, an unallowable operating state, e.g. restricted circulation of the process air (air throughput reduction), is determined by capturing a temperature of the process air in the process-air stream above a heater and before the drying chamber at regular intervals, and forming a difference value from two consecutively captured values in each case, wherein said difference value corresponds to a temporal gradient. This information is not always available in this form in the case of a dryer that is equipped with a heat pump (heat-pump dryer). In a heat-pump dryer, for example, the heat pump is often further away from the drying chamber than the heater in a conventional condensation dryer. In any case, an unallowable operating state in a condensation dryer which is equipped with a heat pump can only be recognized inaccurately in this way.

The invention therefore addresses the problem of providing a condensation dryer comprising a heat pump, and method for the operation thereof, wherein the presence of an unallowable operating state can easily be recognized.

According to the invention, this problem is solved by means of a condensation dryer having the features in the corresponding independent claim, and by the method in the corresponding independent claim. Preferred embodiments of the condensation dryer according to the invention and of the method according to the invention are set out in the corresponding dependent claims. Preferred embodiments of the condensation dryer according to the invention correspond to preferred embodiments of the method according to the invention and vice versa, even if this is not explicitly stated.

The subject matter of the invention is therefore a condensation dryer comprising a drying chamber for the items to be dried, a process-air circuit, a first fan in the process-air circuit, a heat pump, in which a coolant circulates, comprising an evaporator, a compressor, a condenser and a throttle, and a temperature sensor for measuring a temperature of the coolant, a cooling device for the heat pump and a controller, wherein the condensation dryer features first means for comparing a temperature T_{K} of the coolant, this being measured by the temperature sensor, with a limit temperature T_{K}^{lim} which is stored in the controller, and for switching on and operating the cooling device during a time period Δt if T_{K}≧T_{K}^{lim}, and second means for evaluating a change in the temperature T_{K} in the time period Δt with regard to the presence of an unallowable operating state.

In addition to evaporator, condenser and compressor, the heat pump in the inventive condensation dryer features a throttle, which can be configured as an expansion valve, in the flow direction of the coolant between the condenser and the evaporator.

In particular, the evaluation of the change in the temperature T_{K} in the time period Δt can consist in measuring a profile of the temperature T_{K} in the time period Δt and determining the change on the basis of said profile.

The warming of the process air can take place exclusively via the condenser of the heat pump. However, an electric heater can also be provided and only used during specific parts of a drying process if applicable.

In a preferred embodiment of this condensation dryer, the temperature sensor is located at the output of the condenser or at the output of the compressor.

The cooling device preferably comprises an additional heat exchanger in the heat pump. In a particularly preferred embodiment of the corresponding condensation dryer, the additional heat exchanger is arranged in a process-air channel between the evaporator and the condenser.

In an alternative particularly preferred embodiment of the condensation dryer with the additional heat exchanger in the heat pump, the additional heat exchanger is arranged in a cooling-air channel. An air-air heat exchanger is preferably also arranged in this cooling-air channel.

Provision is preferably also made for the cooling device to feature a second fan. Further to this, the second fan is preferably arranged in a cooling-air channel and/or in the vicinity of the compressor.

The condensation dryer according to the invention preferably features an acoustic and/or optical indicator means for indicating an unallowable operating state. An optical indicator means can be a liquid crystal display, for example, on which specific prompts or instructions are given. Additionally or alternatively, provision can be made for LEDs in one or more colors. The type of indicator for an unallowable operating state can depend on the type of the unallowable operating state.

In the case of a generally less critical first unallowable operating state, provision could be made for displaying, e.g. on a liquid crystal display, a prompt to clean the airways in the condensation dryer or to remove some of the items to be dried from the drying chamber. Alternatively or additionally, an LED could be illuminated, e.g. in an orange color.

In the case of a second unallowable operating state, which is usually more critical than the first, an instruction could be output on e.g. a liquid crystal display to the effect that the drying process was interrupted and that a service technician should be contacted. Alternatively or additionally, an LED could be illuminated, e.g. in a red color.

The invention also relates to a method for operating a condensation dryer comprising a drying chamber for the items to be dried, a process-air circuit, a first fan in the process-air circuit, a heat pump, in which a coolant circulates, comprising an evaporator, a compressor, a condenser and a throttle, and a temperature sensor for measuring a temperature of the coolant, a cooling device for the heat pump and a controller, wherein the condensation dryer features first means for comparing a temperature T_{K} of the coolant, this being measured by the temperature sensor, with a limit temperature T_{K}^{lim} which is stored in the controller, and for switching on and operating the cooling device during a time period Δt if T_{K}≧T_{K}^{lim}, and second means for evaluating a change in the temperature T_{K} in the time period Δt with regard to the presence of an unallowable operating state, wherein the method comprises the steps:
(a) switching on the cooling device if the condition T_{K}≧T_{K}^{lim} is satisfied, and operating the cooling device for a predefined time period Δt;
(b) determining the difference ΔT_{K}=T_{K2-T}_{K1}, where T_{K1} is the temperature measured at the temperature sensor when the cooling device is switched on, and T_{K2} is the temperature measured at the temperature sensor after operating the cooling device for the time period Δt; and
(c) evaluating the change ΔT_{K} with regard to determining an unallowable operating state.

In a preferred embodiment of this method, a first unallowable operating state is indicated if ΔT_{K}≧a predefined value ΔT_{K}^{lim1}. The indicator of a first unallowable operating state preferably includes an instruction to clean the airways in the condensation dryer.

In the method according to the invention, provision is preferably made for indicating a second unallowable operating state if ΔT_{K} is greater than or equal to a predefined value ΔT_{K}^{lim2}. In addition to the indication of a second unallowable operating state, provision is preferably made for interrupting a drying process that is in progress.

It applies generally that ΔT_{K}^{lim2}≧ΔT_{K}^{lim1}.

The switching on of the cooling device preferably comprises the switching on of a second fan. In this context, the second fan can be used directly for cooling components of the heat pump, in particular the compressor. The second fan and an additional heat exchanger are preferably arranged in a cooling-air channel. In this context, the additional heat exchanger is preferably also located in the heat pump.

However, the additional heat exchanger can also be arranged in a process-air channel between the evaporator and the condenser of the heat-pump circuit.

In a further preferred embodiment of the condensation dryer according to the invention, the additional heat exchanger is located in a cooling-air channel of an additional air-air heat exchanger.

Due to its function as a heat exchanger, the additional heat exchanger is generally located in two channels, wherein one of these channels inventively belongs to the heat pump and the other channel is the cooling-air channel or the process-air channel. As a cooling system for the coolant, the additional heat exchanger can be arranged between the compressor and the condenser or between the condenser and the throttle.

In the condensation dryer according to the invention, more than one additional heat exchanger can be provided in the heat-pump circuit. For example, a first additional heat exchanger can be located in the process-air channel and a second additional heat exchanger can be located in the cooling-air channel.

If an additional heat exchanger is located in the cooling-air channel, a first preferred embodiment has it arranged between the second fan and an air-air heat exchanger.

In a second preferred embodiment, the additional heat exchanger is arranged in the cooling-air channel on the opposite side of the air-air heat exchanger to the second fan.

In a third preferred embodiment, the additional heat exchanger in the cooling-air channel is arranged on the opposite side of the second fan to an air-air heat exchanger.

The coolant used in the heat pump is preferably chosen from the group consisting of propane, carbon dioxide and fluorinated hydrocarbon compounds. In particular, consideration is given to the fluorinated ethane derivatives known as R134a and R152a and the fluorinated hydrocarbon mixtures known as R407C and R410A as coolants.

In a preferred embodiment of the condensation dryer, the optional air-air heat exchanger is removable. This is particularly advantageous because fluff can be cleaned more easily from a removable heat exchanger.

The coolant used in the heat pump preferably circulates with a turbulent flow. A turbulent flow can be created by a suitable structural configuration of a flow channel and/or by suitable driving means (e.g. compressor).

According to the invention, the temperature of the coolant in the heat pump, in particular in the condenser, is generally held in the allowable range by controlling the heat pump and possibly an additional heat exchanger. If an additional heater is located in the process-air circuit before the entry to the drying chamber in the condensation dryer according to the invention, the controlling of the heat pump is preferably performed in coordination with the controlling of the heater.

According to the invention, process air and cooling air or process air and coolant in the heat pump are preferably carried through the corresponding heat exchanger using an intersection or counterflow method in each case.

According to the invention, improved adjustment of the temperature of the coolant in the heat pump, in particular in the condenser, is provided by the combination of a heat pump with a cooling device, in particular an additional heat exchanger and/or an additional second fan.

If a further heater is used in addition to the heat pump in the condensation dryer according to the invention, this is preferably a two-stage heater. In a preferred embodiment of the invention, the controller for this heater is also used for regulating the temperature of the coolant.

Since the required drying energy decreases as the degree of dryness increases for the items that are to be dried in the condensation dryer, it is appropriate to regulate the heater correspondingly, i.e. to decrease its heat output as the degree of dryness increases, in order to maintain a balance between the supplied drying energy and the required drying energy.

As the degree of dryness increases for the items to be dried (in particular laundry), a lower heat output or even greater cooling performance is therefore required from the heat pump. In particular, the temperature in the process-air circuit will increase sharply after a drying phase is completed. Therefore the heat pump and if applicable an additional heater in the condensation dryer are generally regulated such that a maximum allowable temperature is not exceeded in the drying chamber.

For the purpose of monitoring the coolant temperature or heat pump temperature, and if applicable the temperature of the process air, temperature sensors that are generally familiar to a person skilled in the art are installed in the heat pump and/or in the process-air circuit.

The invention has the advantage that the operation of a condensation dryer can be monitored in a simple and effective manner. Unallowable operating states can be reliably indicated, such that suitable countermeasures can be applied. The heat pump and in particular its condenser can work in an optimum temperature range. This allows the condensation dryer to operate with a particularly favorable energy balance. The heat pump is also protected thus.

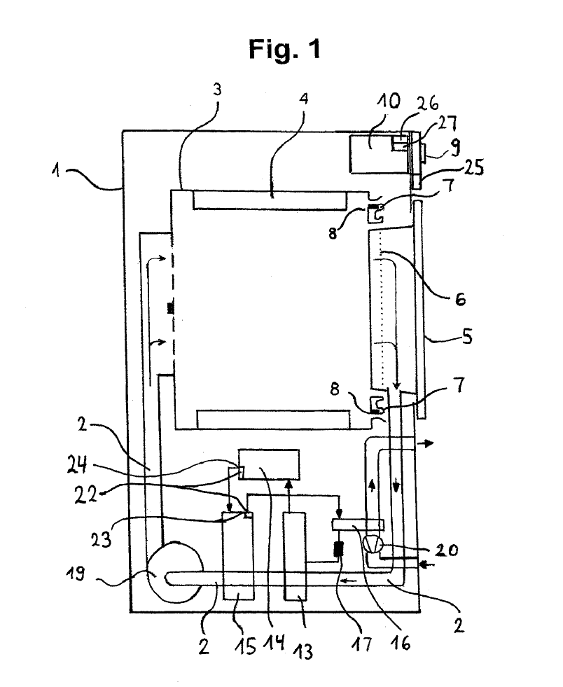

Further details of the invention are derived from the following description of exemplary embodiments for the condensation dryer according to the invention and a method that uses this condensation dryer, wherein said exemplary embodiments do not limit the scope of the invention. Reference is made here to the FIGS. 1 to 5, in which:

FIG. 1 shows a vertical section through a condensation dryer according to a first embodiment.

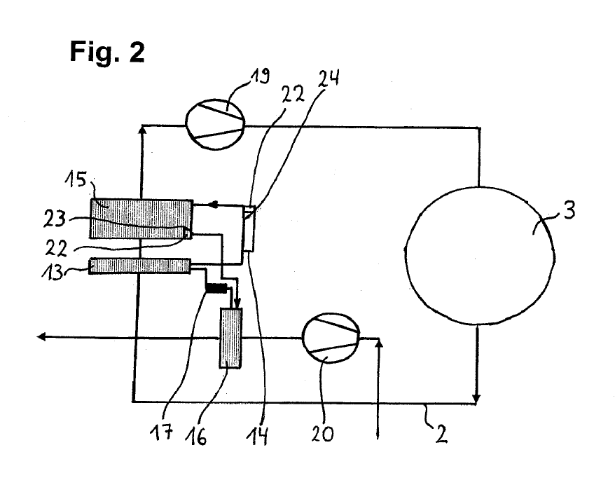

FIG. 2 shows a schematic illustration of the process-air circuit and the heat-pump circuit for the first embodiment as shown in FIG. 1.

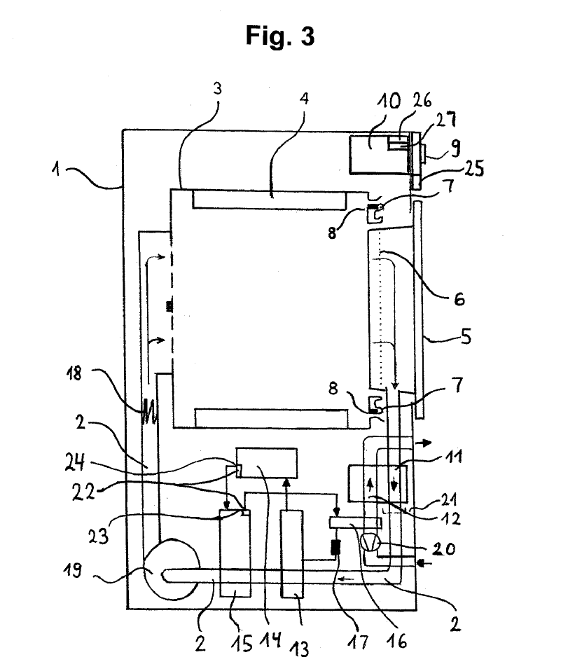

FIG. 3 shows a vertical section through a condensation dryer according to a second embodiment, in which an additional heater and an additional air-air heat exchanger are used.

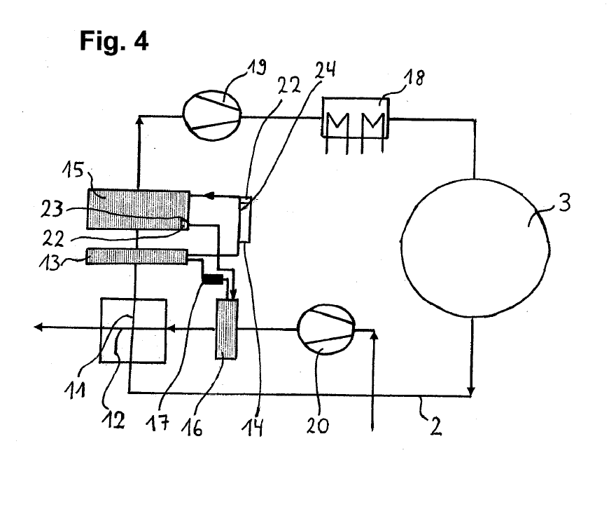

FIG. 4 shows a schematic illustration of the process-air circuit and the heat-pump circuit for the second embodiment as shown in FIG. 3.

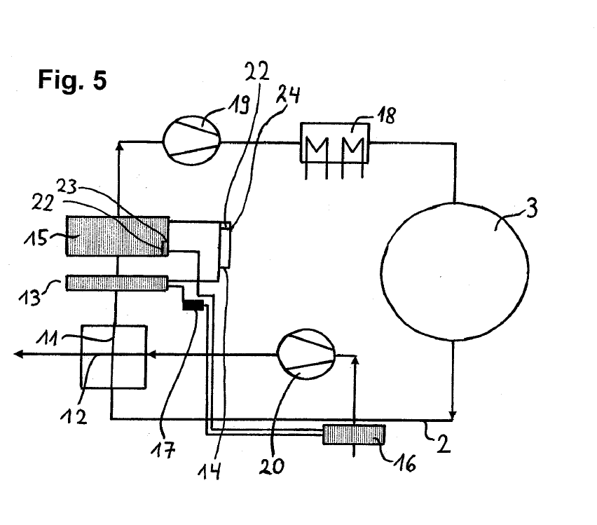

FIG. 5 shows a schematic illustration of the process-air circuit and the heat-pump circuit for a third embodiment.

FIG. 1 shows a vertically sectioned condensation dryer 1 (subsequently abbreviated to “dryer”) according to a first embodiment, in which the heating of the process air takes place exclusively by means of the condenser of the heat pump.

The dryer 1 illustrated in FIG. 1 features a drum 3, as a drying chamber 3, which can be rotated about a horizontal axis and within which pushers 4 are attached for moving laundry during a drum rotation. Process air is carried through a drum 3 and a heat pump 13,14,15 in an air channel 2 in the closed circuit (process-air circuit 2) by means of a fan 19. After passing through the drum 3, the moist warm process air is cooled and, following condensation of the moisture contained in the process air, is warmed again. In this case, warmed air is carried from behind, i.e. from that side of the drum 3 which is opposite to a door 5, through its vented base into the drum 3, where it comes into contact with the laundry to be dried and flows through the load opening of the drum 3 to a fluff filter 6 within a door 5 that seals the load opening. The air stream is then redirected downwards in the door 5 and routed via the air channel 2 to the evaporator 13 of a heat pump 13,14,15,17, where it is cooled. The coolant of the heat pump, which is evaporated in the evaporator 13 in this case, is routed via a compressor 14 to the condenser 15. In the condenser 15, the coolant condenses while emitting heat to the process air. The coolant, which is now present in liquid form, is then carried to an additional heat exchanger 16, which is located in a cooling-air channel 12 with a second fan 20, and from there via a throttle 17 back to the evaporator 13, thereby closing the coolant circuit. The cooling air is taken from the room air and is added to the room air again after the heat exchange.

In the embodiment shown in FIG. 1, the drum 3 is mounted by means of a rotating bearing at its rear base and by means of a bearing bracket 7 at the front, wherein a rim of the drum 3 rests on a sliding strip 8 on the bearing bracket 7 and is held thus at the front end. The control of the condensation dryer is coordinated by means of a controller 10, which can be regulated by the user via an operating unit 9.

In addition to the controller 10, or integrated in the controller 10, the condensation dryer 1 comprises first means 26 for measuring and for comparing a temperature T_{K} of the coolant with a limit temperature T_{K}^{lim} which is stored in the controller 10, and for switching on and operating the cooling device 16,20 during a predefined time period Δt if T_{K}≧T_{K}^{lim}, and second means for evaluating a change in the temperature T_{K} in the time period Δt with regard to the presence of an unallowable operating state.

23 signifies the output of the condenser 15. 24 signifies the output of the compressor 14. In the case of the embodiment shown in FIG. 1, a temperature sensor 22 is arranged at the outputs 23 and 24 in each case.

An optical indicator means 25 serves to indicate an unallowable operating state, wherein various colors can indicate different unallowable operating states.

FIG. 2 shows a schematic illustration of the process-air circuit and the heat pump for the first embodiment of a condensation dryer as shown in FIG. 1. While the process air is carried in the closed process-air circuit 2 and the coolant is carried in the closed heat-pump circuit of the heat pump 13,14,15,17, the air that is used for cooling in the additional heat exchanger 16 is taken from the room air by means of the second fan 20 and, after passing through the additional heat exchanger 16, is added to the room air again.

FIG. 3 shows a vertically sectioned condensation dryer (subsequently abbreviated to “dryer”) according to a second embodiment, in which an additional heat exchanger is located in both the heat-pump circuit and in the cooling-air channel of an air-air heat exchanger.

The dryer 1 illustrated in FIG. 3 features a drum as a drying chamber 3, which can be rotated about a horizontal axis and within which pushers 4 are attached for moving laundry during a drum rotation. Process air is carried via a heater 18 through a drum 3, an air-air heat exchanger 11,12, and a heat pump 13,14,15,17 in an air channel 2 in the closed circuit (process-air circuit 2) by means of a fan 19. After passing through the drum 3, the moist warm process air is cooled and, following condensation of the moisture contained in the process air, is warmed again. In this case, air that has been warmed by the heater 18 is carried from behind, i.e. from that side of the drum 3 which is opposite to a door 5, through its vented base into the drum 3, where it comes into contact with the laundry to be dried and flows through the load opening of the drum 3 to a fluff filter 6 within a door 5 that seals the load opening. The air stream is then redirected downwards in the door 5 and routed by the air channel 2 to the air-air heat exchanger 11,12. The moisture that is taken from the process air out of the laundry items condenses there after cooling, and is collected in a condensation container 21 which is broken marked in FIG. 3 and from which it can be disposed. The process air that has been to some extent cooled is then carried to the evaporator 13 of a heat pump 13,14,15,17, where it is cooled further. The coolant of the heat pump, which is evaporated in the evaporator 13 in this way, is routed via the compressor 14 to the condenser 15. In the condenser 15, the coolant condenses while emitting heat to the process air. The coolant, which is now present in liquid form, is then carried to an additional heat exchanger 16, which is located in the cooling-air channel 12 of the air-air heat exchanger 11,12, between this and a second fan 20, and from there via a throttle 17 back to the evaporator 13, thereby closing the coolant circuit. The cooling air is taken from the room air and is added to the room air again after passing through the air-air heat exchanger 11,12.

In the embodiment shown in FIG. 3, the drum 3 is mounted by means of a rotating bearing at its rear base and by means of a bearing bracket 7 at the front, wherein a rim of the drum 3 rests on a sliding strip 8 on the bearing bracket 7 and is held thus at the front end. The control of the condensation dryer is coordinated by means of a controller 10, which can be regulated by the user via an operating unit 9.

In addition to the controller 10, or integrated in the controller 10, the condensation dryer 1 comprises first means 26 for comparing a temperature T_{K} of the coolant with a limit temperature T_{K}^{lim} which is stored for the coolant in the controller 10, and for switching on and operating the cooling device 16,20 during a time period Δt if T_{K}≧T_{K}^{lim}, and second means for evaluating a change in the temperature T_{K} in the time period Δt with regard to the presence of an unallowable operating state.

23 signifies the output of the condenser 15. 24 signifies the output of the compressor 14. In the case of the embodiment shown in FIG. 3, a temperature sensor 22 is arranged at the outputs 23 and 24 in each case.

An optical indicator means 25 serves to indicate an unallowable operating state.

FIG. 4 shows a schematic illustration of the process-air circuit and of the heat-pump circuit for the second embodiment of a condensation dryer as shown in FIG. 3. While the process air is carried in the closed process-air circuit 2 and the coolant is carried in the closed heat-pump circuit of the heat pump 13,14,15,17, the air that is used for cooling in the air-air heat exchanger 11,12 is taken from the room air, routed via the second fan 20 to the air-air heat exchanger 11,12 (after passing through the additional heat exchanger 16) and then added to the room air again.

FIG. 5 shows a schematic illustration of the process-air circuit and of the heat-pump circuit for a third embodiment of the condensation dryer according to the invention. In this embodiment, the additional heat exchanger 16 is arranged in the cooling-air channel 12 on the opposite side of the second fan 20 to the air-air heat exchanger 11,12. The heat exchanger 16 is therefore situated in the intake region of the cooling air.

1-16. (canceled)

17. A condensation dryer, comprising:
a drying chamber for items to be dried;
a process-air circuit having a first fan;
a heat pump in which a coolant circulates;
an evaporator;
a compressor;
a condenser;
a throttle;
a temperature sensor to measure a temperature of the coolant;
a cooler for the heat pump;
a controller;
a comparator to compare the measured temperature of the coolant to a limit temperature stored in the controller and to switch on and operate the cooler during a time period if the measured temperature of the coolant is equal to or greater than the limit temperature; and
an evaluator to evaluate a change in the measured temperature of the coolant during the time period with regard to the presence of a non-permitted operating state of the condensation dryer.

18. The condensation dryer of claim 17, wherein the compressor has a compressor output and the condenser has a condenser output, and wherein the temperature sensor is at one of the compressor output and the condenser output.

19. The condensation dryer of claim 17, wherein the cooler has a heat exchanger in the heat pump.

20. The condensation dryer of claim 19, wherein the heat exchanger is in a process-air channel between the evaporator and the condenser.

21. The condensation dryer of claim 19, wherein heat exchanger is in a cooling-air channel.

22. The condensation dryer of claim 17, wherein the cooler has a second fan.

23. The condensation dryer of claim 22, wherein the second fan is in at least one of a cooling-air channel and a vicinity of the compressor.

24. The condensation dryer of claim 17, further comprising at least one of an acoustic indicator an and optical indicator to indicate the non-permitted operating state of the condensation dryer.

25. A method for operating a condensation dryer, the condensation dryer having a drying chamber for items to be dried, a process-air circuit, a first fan in the process-air circuit, a heat pump in which a coolant circulates, an evaporator, a compressor, a condenser, a throttle, a temperature sensor to measure a temperature of the coolant, a cooler for the heat pump, a controller, a comparator to compare the measured temperature of the coolant to a limit temperature stored in the controller and to operate the cooler during a time period if the measured temperature of the coolant is equal to or greater than the limit temperature, and an evaluator to evaluate a change in the measured temperature of the coolant during the time period with regard to the presence of a non-permitted operating state of the condensation dryer, the method comprising:
if the measured temperature of the coolant is equal to or greater than the limit temperature, switching on the cooler and operating the cooler for the time period;
determining a temperature difference between a first temperature measured at the temperature sensor when the cooling device is switched on and a second temperature measured at the temperature sensor after operating the cooler for the time period; and
evaluating the temperature difference with regard to determining the non-permitted operating state of the condensation dryer.

26. The method of claim 25, wherein a first non-permitted operating state is indicated if the temperature difference is equal to or greater than a first predefined value.

27. The method of claim 26, wherein the indication of the first non-permitted operating state includes an instruction to clean airways in the condensation dryer.

28. The method of claim 25, wherein a second non-permitted operating state is indicated if the temperature difference is equal to or greater than a second predefined value.

29. The method of claim 28, wherein, in addition to indicating the second non-permitted operating state, a drying process in progress is interrupted.

30. The method of claim 25, wherein the switching on of the cooler includes switching on a second fan.

31. The method of claim 30, wherein the second fan and a heat exchanger are in a cooling-air channel.

32. The method of claim 31, wherein the heat exchanger is in the heat pump.
